(19) United States
(12) Patent Application Publication
(10) Pub. No.: US 2002/0053027 A1
(43) Pub. Date: May 2, 2002

(54) Method for preventing theft of vehicles by performing ignition key authorization

(76) Inventor: Hee-Jun Kim, Hwaseong-kun (KR)

Correspondence Address: CHRISTIE, PARKER & HALE, LLP, 350 WEST COLORADO BOULEVARD, SUITE 500, PASADENA, CA, 91105, US

(21) Appl. No.: 09/964,239

(22) Filed: Sep. 25, 2001

(30) Foreign Application Priority Data
Sep. 25, 2000 (KR) 2000-56124

(51) Int. Cl. H04L 9/00

(52) U.S. Cl. 713/183

(57) ABSTRACT

Disclosed is a method for performing authorization of an ignition key by using an engine control unit (ECU) and an ignition key that stores a key ID, a lock password and a key password. The method comprises the steps of (1) the ECU receiving the key ID from the ignition key and determining if the key ID is a registered ID; (2) generating, if the key ID is a registered ID, a random number and encoding a stored lock password using the random number, and transmitting the random number and the encoded lock password to a transponder of the ignition key; (3) the transponder decoding the lock password using the received random number and encoded lock password, then determining if the decoded lock password is identical to a stored lock password; (4) the transponder encoding a key password using the stored key password, and transmitting the encoded key password to the ECU; (5) the ECU decoding the received encoded key password, then determining if the decoded key password is identical to a stored key password; and (6) releasing an ignition lock state if the decoded key password is identical to the stored key password.

### CROSS-REFERENCE TO RELATED APPLICATION

This application claims priority of Korea patent Application No. 2000-56124, filed on Sep. 25, 2000.

### BACKGROUND OF THE INVENTION

(a) Field of the Invention

The present invention relates to a method for preventing the theft of vehicles by performing ignition key authorization, and more particularly, to a method for preventing the theft of vehicles by performing ignition key authorization in which coding and authorization are performed without the use of a separate authorization unit.

(b) Description of the Related Art

Most large cities of the world have experienced a continuously increasing number of vehicles being stolen each year, or at least the maintenance of consistently high levels of car theft. Accordingly, many automobile manufacturers provide their vehicles with car alarms, and continue research into improved ways to prevent car theft.

One relatively new method of preventing the theft of vehicles is that of using an ignition key that is installed with a unique code that the vehicle recognizes. That is, a fixed code is commonly assigned to an integrated circuit (IC) installed in the ignition key, and the vehicle may be started only if authorization of the specific code occurs.

However, with the use of the prior art ignition key authorization method, a separate code authorization unit is required to decipher the code installed in the IC provided in the ignition key to thereby enable an engine control unit to authorize the code. The engine control unit determines whether to allow the engine to be started based on an authorization signal output from the code authorization unit.

As a result, the number of parts needed for the entire system is increased with the use of the separate code authorization unit. Further, the system may not be fully secure since whether to permit the starting of the engine is performed by the engine control unit based on a transmitted signal (from the code authorization unit). For example, a code scanner or code grabber may be used to defeat the system.

### SUMMARY OF THE INVENTION

The present invention has been made in an effort to solve the above problems.

It is an object of the present invention to provide a method for preventing the theft of vehicles by performing authorization of an ignition key, in which coding and authorization are performed in an engine control unit without the use of a separate authorization unit, and in which undesired decoding is made difficult through the use of multi-step bit operations.

To achieve the above object, the present invention provides a method for performing authorization of an ignition key by using an engine control unit (ECU) and an ignition key that stores a key ID, a lock password and a key password, the method comprising the steps of (1) the ECU receiving the key ID from the ignition key and determining if the key ID is a registered ID; (2) generating, if the key ID is the registered ID, a random number and encoding a stored lock password using the random number, and transmitting the random number and the encoded lock password to a transponder of the ignition key; (3) the transponder decoding the lock password using the received random number and encoded lock password, then determining if the decoded lock password is identical to a stored lock password; (4) the transponder encoding a key password using a stored key password, and transmitting by the transponder the encoded key password to the ECU; (5) the ECU decoding the received encoded key password, then determining if the decoded key password is identical to the stored key password; and (6) releasing an ignition lock state if the decoded key password is identical to the stored key password.

According to a feature of the present invention, the ECU includes shift registers T and S, and the encoding of the lock password in step (2) comprises the steps of (7) initializing and modulating the shift registers T and S using the random number; (8) generating a first cession key; and (9) encoding the stored lock password using the first cession key, and wherein the decoding of the lock password using the random number and encoded lock password in step (3) are performed using the same processes involved in encoding the stored lock password using the random number of step (2).

According to another feature of the present invention, the initialization of the shift registers of step (7) includes the step of generating a random number, and wherein the shift register modulation of step (7) is realized by designating a plurality of functions that receive input of a plurality of bit values and calculate a single bit value; designating an F2 function that receives input of calculation result values from the functions and calculates bit values; and repeating processes in which the shift registers T and S are shifted to the left, and determining an LSB of the shift register S using the F2 function values and the random number.

According to yet another feature of the present invention, in the generation of the first cession key of step (8), a plurality of functions are designated that receive input of a plurality of bit values and calculate a single bit value, an F3 function is designated that receives input of calculation result values from the functions and calculates bit values, and bits of the first cession key are calculated from the F3 function values.

According to still yet another feature of the present invention, the plurality of functions is identical to the plurality of functions of step (7), and the F3 function is identical to the F2 function.

According to still yet another feature of the present invention, the ECU includes shift registers T and S, wherein encoding of the stored key password of step (4) comprises the steps of (10) generating a second cession key; and (11) encoding the stored key password using the second cession key, and wherein the decoding of the encoded key password in step (5) is performed using the same processes as are involved in the encoding of the key password.

According to still yet another feature of the present invention, in the generation of the second cession key of step (10), a plurality of functions are designated that receive input of a plurality of bit values and calculate a single bit value, an F4 function is designated that receives input of calculation result values from the functions and calculates bit values, and bits of the second cession key are calculated from the F4 function values.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic view of an ignition key authorization system and related elements to which a method of a preferred embodiment of the present invention is applied;

FIG. 2 is a flow chart of a method for preventing the theft of vehicles by performing authorization of an ignition key according to a preferred embodiment of the present invention;

FIG. 3 is a drawing for describing initialization and modulation of shift registers T and S according to a preferred embodiment of the present invention;

FIG. 4 is a flow chart of a modulation process of shift registers T and S according to a preferred embodiment of the present invention;

FIG. 5 is a drawing for describing the generation of a first cession key according to a preferred embodiment of the present invention;

FIG. 6 is a flow chart of a process for generating a first cession key according to a preferred embodiment of the present invention; and

FIG. 7 is a flow chart of a process for generating OUTPUT(i), which is performed in a step of determining S0 of FIG. 6.

### DETAILED DESCRIPTION OF THE PREFERRED EMBODIMENTS

Preferred embodiments of the present invention will now be described in detail with reference to the accompanying drawings.

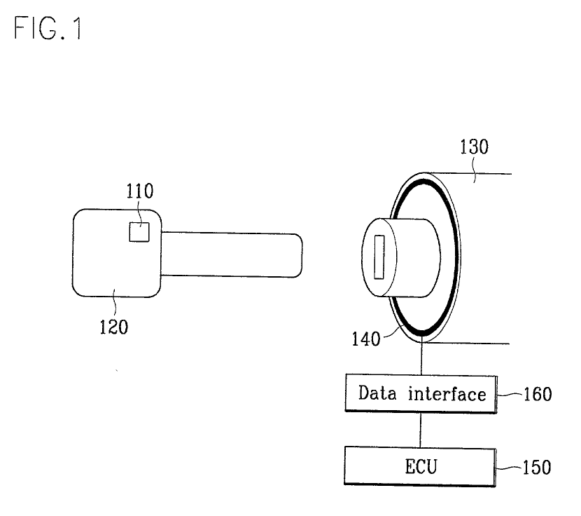

FIG. 1 shows a schematic view of an ignition key authorization system and related elements to which a method of a preferred embodiment of the present invention is applied.

An ignition key authorization system and related elements includes an ignition key 120 in which there is installed a transponder 110, which decodes an inputted code, calculates a code, and performs encryption of a calculated signal; a key box 130 including a key opening into which the ignition key 120 is inserted, the key box 130 transmitting and receiving signals with the ignition key 120; and an engine control unit 150 for transmitting and receiving code signals between the key box 130.

A coil antenna 140 is provided within the key box 130. Data is transmitted and received between the key box 130 and the transponder 110 of the ignition key 120 through the coil antenna 140. Further, the engine control unit 150 is connected to the coil antenna 140 via a data interface 160 such that data is transmitted and received therebetween.

The transponder 110 of the ignition key 120 is realized through an IC chip that is able to perform encryption, decoding, and calculations. Also, the engine control unit 150 is realized through a conventional electronic control unit (ECU). Stored in the transponder 110 are a 4-byte key identifier (hereinafter referred to as an ID), a 6-byte authenticator (hereinafter referred to as AUTHEN) for authenticating a code, and a 4-byte lock password and key password.

Shift registers T and S are provided in the engine control unit 150 for encoding, decoding and performing calculations. Also, key ID, AUTHEN, lock password and key password identical to those stored in the transponder 110 are stored in the engine control unit 150.

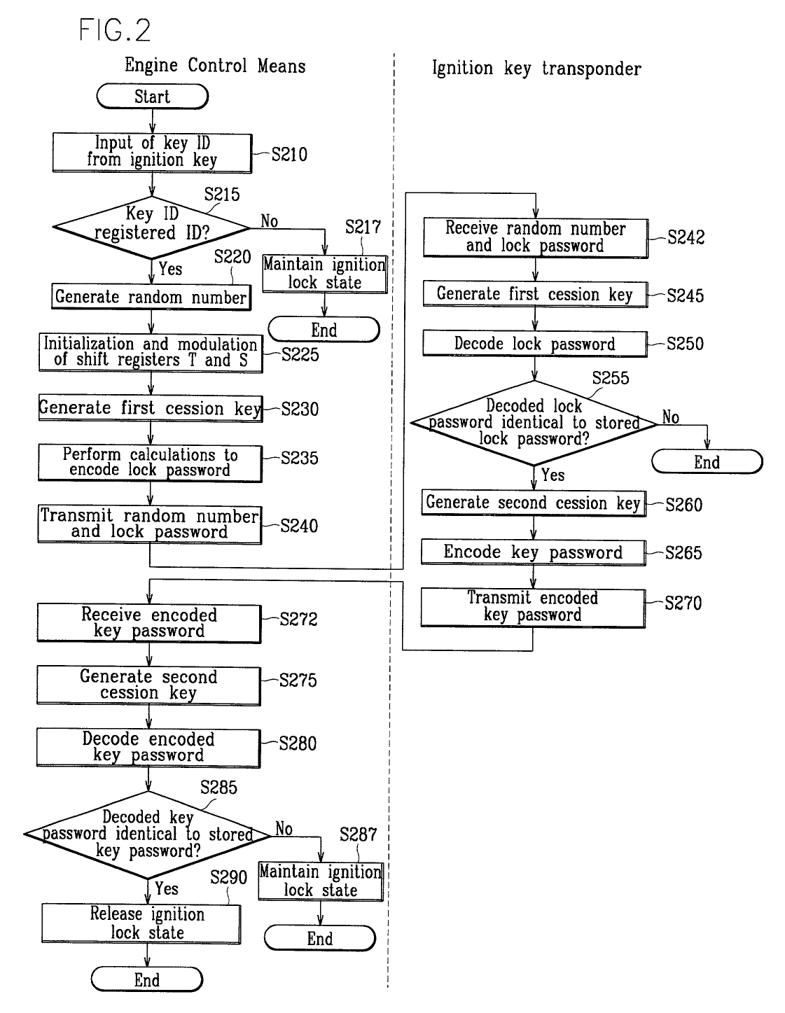

FIG. 2 shows a flow chart of a method for preventing the theft of vehicles by performing authorization of an ignition key according to a preferred embodiment of the present invention.

First, if the ignition key 120 is inserted in the key box 130, the engine control unit 150 receives input of a key ID from the transponder 110 installed in the ignition key 120 in step S210. Next, the engine control unit 150 determines if the key ID is a registered ID in step S215. If it is determined that the key ID is not a registered ID, an ignition lock state in which ignition is not possible is maintained in step S217. In the ignition lock state, the supply of fuel may be blocked and output of the ignition system may be prevented.

However, if it is determined that the key ID is a registered ID in step S215, a 4-byte random number (RN) is generated in step S220. Next, initialization and modulation of the shift registers T and S based on the input key ID and stored AUTHEN are performed in step S225. The modulation of the shift registers T and S is performed based on the inputted key ID, stored AUTHEN, and RN after the shift registers T and S are initialized.

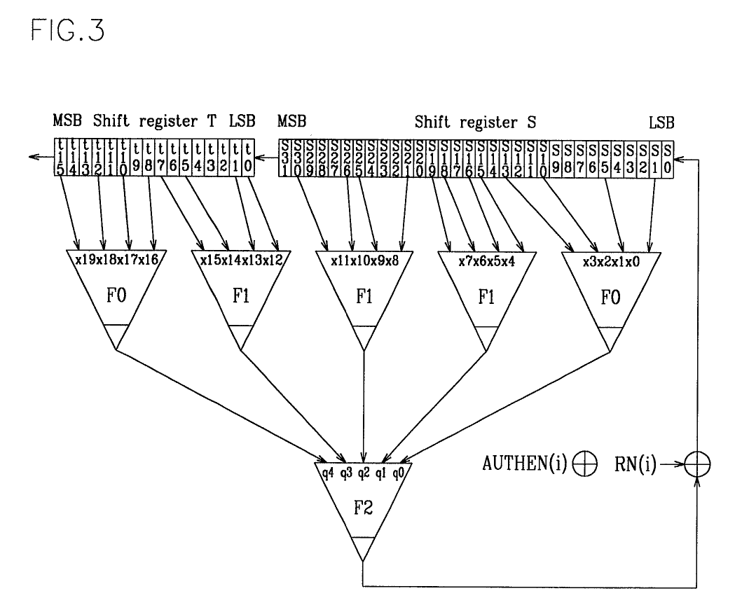

FIG. 3 is a drawing for describing the initialization and modulation of the shift registers T and S.

With reference to FIG. 3, the shift registers T and S are arranged from most significant bit (MSB) to least significant bit (LSB). An LSB of the shift register T is adjacent to a MSB of the shift register S. The shift register T stores an ID0 and ID1 byte of the key ID (four bytes of ID0, ID1, ID2 and ID3) input from the transponder 110, and the shift register S sequentially stores ID2 and ID3 of the key ID, and four bytes of AUTHEN4 and AUTHEN5 of the stored AUTHEN (6 bytes of AUTHEN0 TO AUTHEN5). Each bit of the shift register S is indexed from LSB to MSB (S0 to S31), and each bit of the shift register T is indexed from LSB to MSB (T0 to T5).

After the shift registers S and T are initialized as described above, the LSB of the shift register S is calculated using established functions F0, F1 and F2. By repeating the process for shift calculation of the shift registers T and S, the shift registers T and S are modulated. The functions F0 and F1 are functions that use 4 bits as input values to calculate a single bit, and the function F2 is a function that uses 5 bits as input values to calculate a single bit. That is, the function values are calculated as follows.

$$F0 ( a , b , c , d ) = \overline{( a \times b \times \overline{d} ) + ( a \times \overline{c} \times \overline{d} ) + ( b \times c \times d ) + ( \overline{b} \times \overline{c} \times d ) + ( \overline{a} \times \overline{b} \times \overline{c} \times \overline{d} )}$$

$$F1 ( a , b , c , d ) = \overline{( c \times d ) + ( \overline{a} \times \overline{b} \times c ) + ( \overline{a} \times \overline{b} \times d ) + ( a \times \overline{c} \times \overline{d} )}$$

$$F2 ( a , b , c , d , e ) = \overline{( c \times d \times e ) + ( \overline{a} \times b \times \overline{e} ) + ( a \times \overline{b} \times c ) +} \overline{( b \times \overline{c} \times \overline{d} \times e ) + ( a \times \overline{b} \times d \times e ) + ( \overline{a} \times \overline{c} \times d \times \overline{e} ) + ( a \times b \times \overline{c} \times d \times \overline{e} )}$$

However, values calculated from the shift registers T and S are used by the 5 bits that are used as an input value of F2. That is, if Q0, Q1, Q2, Q3 and Q4 are the input values of the F2 function, values calculated as follows are input and calculated: Q0=F0(S1, S5, S10, S13), Q1=F1(S15, S16, S18, S19), Q2=F1(S21, S25, S26, S30), Q3=F1(T0, T1, T5, T7), and Q4=F0(T8, T10, T12, T15).

Regarding AUTHEN in the above, each bit of the 4 bytes (32 bits) from AUTHEN0 to AUTHEN3 is indexed in AUTHEN(i), and each bit of RN is indexed in RN(i).

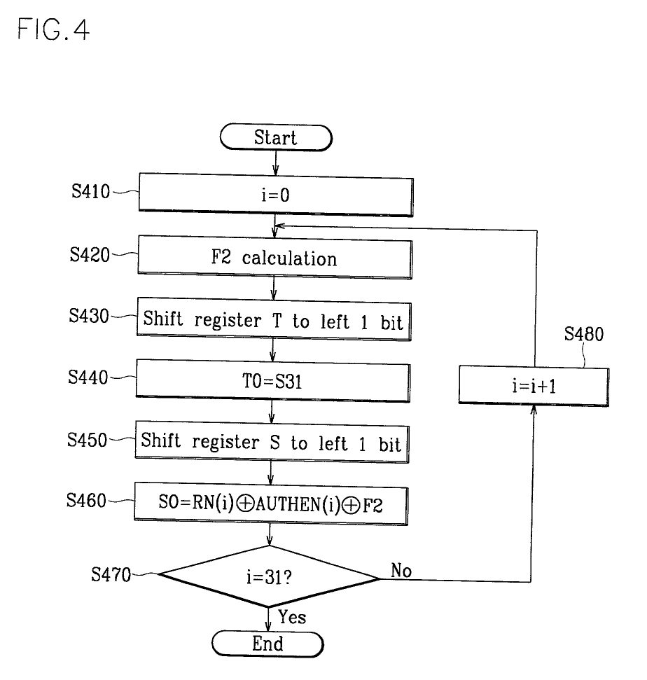

The bits according to the results of the F2 calculation are combined and calculated repeatedly with AUTHEN(i) and RN(i) such that the shift registers T and S are modulated. That is, the modulation of the shift registers T and S is realized through the processes shown in the flow chart of FIG. 4.

First, variable i is assigned the value 0 in step S410, and F2 calculations as in the above are performed in step S420. Next, shift register T is shifted 1 bit to the left in step S430, a value of S31 is assigned to T0 in step S440, and shift register S is shifted to the left 1 bit in step S450.

Subsequently, RN(i), AUTHEN(i), and the F2 calculation resulting value are assigned to S0. That is, an RN(i) AUTHEN(i) F2 calculation resulting value is assigned to S0. The symbol “ ” denotes an XOR operation, in which a 1 is output if the values on left and right sides of the operator are different from each other and a 0 is output if the values are the same.

After step S460, it is determined if i=31 in step S470. If i equals 31, the process is ended. However, if i does not equal 31, i is incremented by 1 in step S480, after which the process is returned to step S420. As a result of this loop, until i takes on the value of 31, the shift registers T and S undergo a total of 32 shift operations (including when i=0).

Referring back to FIG. 2, after the initialization and modulation of the shift registers T and S, a first cession key is generated using the modulated shift registers T and S, and an established internal key in step S230. The first cession key is established as a 6-byte number.

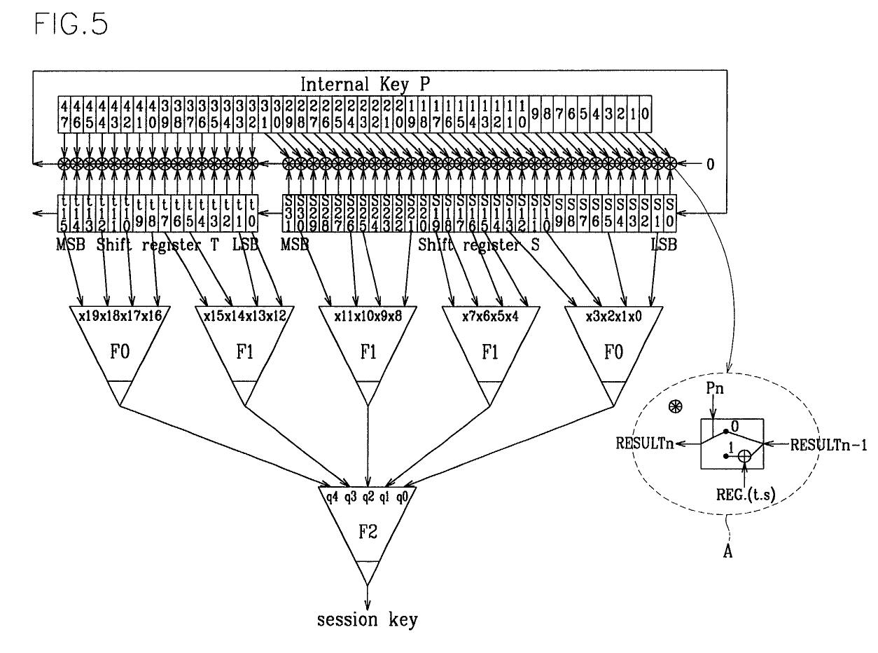

FIG. 5 shows a drawing for describing the generation of the first cession key.

With reference to the drawing, the initialized shift registers T and S are arranged from MSB to LSB, and an LSB of the shift register T is adjacent to a MSB of the shift register S. The internal key is arranged corresponding to bits of the shift registers T and S.

To generate the first cession key, F0, F1 and F2 functions, which calculate bits from the shift registers T and S, are defined. F0, F1 and F2 functions are defined as the same functions as when initializing the shift registers T and S.

Each bit of the first cession key is calculated by the F2 function. After one bit of the first cession key is calculated, left shifts of the shift registers T and S are calculated, and a SO bit is determined by a specifically designated calculation as shown in A of FIG. 5. This process is repeated to calculate the first cession key.

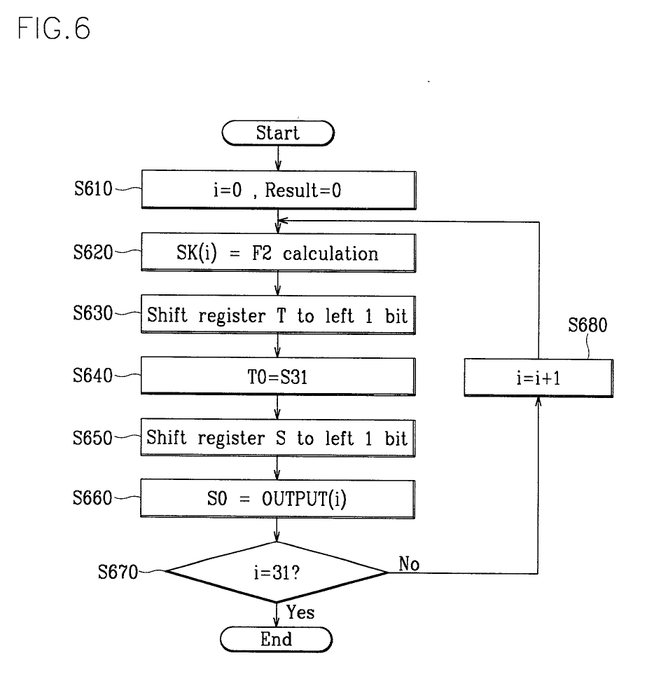

FIG. 6 shows a flow chart of a process for generating the first cession key.

First, variable i and a result value are assigned the value 0 to thereby complete initialization of the variables in step S610. Next, F2 calculations are performed as in the above such that an i-th bit value of the first cession key is obtained in step S620. Subsequently, shift register T is shifted 1 bit to the left in step S630, a value of S31 is assigned to T0 in step S640, and shift register S is shifted to the left 1 bit in step S650.

Following step S650, OUTPUT(i) is generated by a predetermined OUTPUT function and is assigned to S0 in step S660. Next, it is determined if i =31 in step S670. If i equals 31, the process is ended. However, if i does not equal 31, i is incremented by 1 in step S680, after which the process is returned to step S620. As a result of this loop, until i takes on the value of 31, the shift registers T and S undergo a total of 32 shift operations (including when i=0).

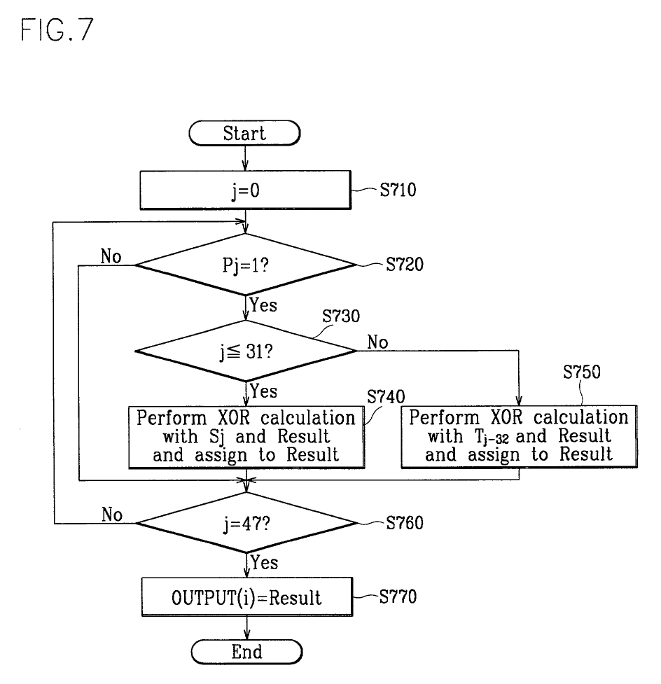

FIG. 7 is a flow chart of a process for generating OUTPUT(i) of step S650 of FIG. 6.

First, variable j is assigned the value 0 in step S710. Next, it is determined whether a j-th bit Pj equals 1 in step S720. If Pj equals 1, it is determined if j is less than or equal to 31 in step S730. If j is less than or equal to 31, an XOR operation is performed with Sj (j-th bit of register S) and variable Result, after which the result is assigned to the variable Result in step S740. However, if j is greater than 31, an XOR operation is performed with Tⱼ₋₃₂ ((j−32)-th bit of register T) and variable Result, after which the result is assigned to the variable Result in step S750.

If Pj does not equal 1 in step S720 or after steps S740 and S750, it is determined if j equals 47 in step S760. If j does not equal 47, the process is returned to step S720 such that calculation with respect to all bits of the internal key can be performed. However, if j equals 47 in step S760, the Result value is assigned to OUTPUT(i) in step S770. Step S660 of FIG. 6 is thereby completed with the above operations.

Referring again to FIG. 2, following the generation of the first cession key in step S230, calculations to encode a lock password are performed in step S235. A stored lock password and the first cession key are used in encoding the lock password. That is, an XOR operation is performed on the lock password and the first cession key, which are each comprised of 4 bits.

Next, the engine control unit 150 transmits the random number and lock password to the transponder in step S240, and the transponder 110 receives the random number and lock password in step S242. The transponder 110 then generates a first cession key in step S245 using the same processes as in steps S225 and S230. That is, the first cession key is generated by the transponder 110 using the same logic as when generated in steps S225 and S230 such that the first cession key is generated according to the logic by a circuit configuration even if shift registers are not included in the transponder 110. Accordingly, the first cession key generated by the transponder 110 is identical to the first cession key generated by the engine control unit 150.

Following step S245, the transponder 110 performs an XOR operation on the first cession key and the lock password such that the lock password is decoded in step S250. That is, using the identical first cession keys, the XOR operation is repeated such that encryption and decoding are possible.

Next, the transponder 110 determines if the decoded lock password is identical to a stored lock password in step S255. If the passwords are not identical, the processes involved in the ignition key authorization method of the present invention are discontinued and the ignition lock state is maintained. However, if the passwords match, a second cession key is generated in step S260 based on the modulated shift registers T and S using the same processes involved in step S230.

The transponder 110, which generates the second cession key, then performs an XOR operation on the stored key password and generated second cession key such that a key password is encoded in step S265. The encoded key password is then transmitted to the engine control unit 150 in step S270, and the engine control unit 150 receives the password in step S272.

Subsequently, the engine control unit 150, using identical processes as those involved in the generation of the first cession key of step S230, generates a second cession key based on the values of the modulated shift registers T and S in step S275. The engine control unit 150 then performs an XOR operation on the generated second cession key and the received key password such that the key password is decoded in step S280.

Next, the engine control unit 150 determines if the decoded key password is identical to a stored key password in step S285. If the passwords are not identical, the ignition lock state in which ignition is not possible is maintained in step S287. However, if the passwords match, the ignition lock state is released in step S290. That is, fuel supply and ignition system output are permitted.

In the method of the present invention described above, security is increased by performing the encoding and decoding of various passwords in the engine control unit. Further, the reliability of codes is increased by performing encoding and decoding in multiple steps of bit operations. Also, since no additional system is required to perform ignition key authorization, manufacturing processes and overall costs are reduced, and space needed for such an extra system is saved.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A method for performing authorization of an ignition key by using an engine control unit (ECU) and an ignition key that stores a key ID, a lock password and a key password, the method comprising the steps of:
(1) the ECU receiving the key ID from the ignition key and determining if the key ID is a registered ID;
(2) generating, if the key ID is the registered ID, a random number and encoding a stored lock password using the random number, and transmitting the random number and the encoded lock password to a transponder of the ignition key;
(3) the transponder decoding the lock password using the received random number and encoded lock password, then determining if the decoded lock password is identical to a stored lock password;
(4) the transponder encoding a key password using a stored key password, and transmitting the encoded key password to the ECU;
(5) the ECU decoding the received encoded key password, then determining if the decoded key password is identical to the stored key password; and
(6) releasing an ignition lock state if the decoded key password is identical to the stored key password.

2. The method of claim 1 wherein the ECU includes shift registers T and S, and the encoding of the lock password in step (2) comprises the steps of:
(7) initializing and modulating the shift registers T and S using the random number;
(8) generating a first cession key; and
(9) encoding the stored lock password using the first cession key, and wherein the decoding of the lock password using the random number and encoded lock password in step (3) are performed using the same processes involved in encoding the stored lock password using the random number of step (2).

3. The method of claim 2 wherein the initialization of the shift registers of step (7) includes the step of generating a random number, and wherein the shift register modulation of step (7) is realized by designating a plurality of functions that receive input of a plurality of bit values and calculate a single bit value; designating an F2 function that receives input of calculation result values from the functions and calculates bit values; and repeating processes in which the shift registers T and S are shifted to the left, and determining an LSB of the shift register S using the F2 function values and the random number.

4. The method of claim 3 wherein in the generation of the first cession key of step (8), a plurality of functions are designated that receive input of a plurality of bit values and calculate a single bit value, an F3 function is designated that receives input of calculation result values from the functions and calculates bit values, and bits of the first cession key are calculated from the F3 function values.

5. The method of claim 4 wherein the plurality of functions is identical to the plurality of functions of step (7), and the F3 function is identical to the F2 function.

6. The method of claim 1 wherein the ECU includes shift registers T and S,
wherein encoding of the stored key password of step (4) comprises the steps of:
(10) generating a second cession key; and
(11) encoding the stored key password using the second cession key, and wherein the decoding of the encoded key password in step (5) is performed using the same processes as are involved in the encoding of the key password.

7. The method of claim 6 wherein in the generation of the second cession key of step (10), a plurality of functions are designated that receive input of a plurality of bit values and calculate a single bit value, an F4 function is designated that receives input of calculation result values from the functions and calculates bit values, and bits of the second cession key are calculated from the F4 function values.
